(19) United States
(12) Patent Application Publication
(10) Pub. No.: US 2014/0007493 A1
(43) Pub. Date: Jan. 9, 2014

(54) HYBRID SILICA AND ALUMINA AS CATALYST MATRIX AND/OR BINDER IN BIOMASS CONVERSION CATALYSTS AND BIO-OIL UPGRADING

(71) Applicants: Christine M. Henry, Houston, TX (US); Stephen Schuylen, Houston, TX (US); Jerry J. Springs, Leagye City, TX (US); Dennis Stamires, Dana Point, CA (US); Zongchao Zhang, Norwood, NJ (US); Ling Zhou, Houston, TX (US)

(72) Inventors: Christine M. Henry, Houston, TX (US); Stephen Schuylen, Houston, TX (US); Jerry J. Springs, Leagye City, TX (US); Dennis Stamires, Dana Point, CA (US); Zongchao Zhang, Norwood, NJ (US); Ling Zhou, Houston, TX (US)

(73) Assignee: KiOR, Inc., Pasadena, TX (US)

(21) Appl. No.: 13/933,985

(22) Filed: Jul. 2, 2013

Related U.S. Application Data
(60) Provisional application No. 61/668,624, filed on Jul. 6, 2012.

(51) Int. Cl. B01J 29/40

(52) U.S. Cl. CPC B01J 29/40
USPC 44/307; 502/263; 502/68; 502/64

(57) ABSTRACT

The invention relates to catalyst compositions and components thereof for use in a catalytic process, and more particularly in a catalytic pyrolysis process or gasification of solid biomass material. In one aspect, a catalyst component is provided. The catalyst component includes a hybrid silica-alumina having a controlled Lewis acidity, and having a controlled porosity providing optimized accessibility for reactants.

### CROSS REFERENCE TO RELATED APPLICATIONS/INCORPORATION BY REFERENCE STATEMENT

This application claims the benefit of co-pending U.S. Provisional Application No. 61/668,624, filed Jul. 6, 2012, which is hereby incorporated by reference in its entirety herein. This application, and co-pending U.S. Provisional Application No. 61/668,624, make reference to U.S. Provisional Patent Application entitled “MESOPOROUS ZEOLITE-CONTAINING CATALYSTS FOR THE THERMOCONVERSION OF BIOMASS AND FOR UPGRADING BIO-OILS”, Attorney Docket No. ID 269-270US-PRO, filed on Jul. 6, 2012; to U.S. Provisional Patent Application No. 61/600,148, entitled “CATALYST COMPOSITIONS COMPRISING 1N SITU GROWN ZEOLITES ON CLAY MATRIXES EXHIBITING HIERARCHICAL PORE STRUCTURES”, Attorney Docket No. ID 223-228US-PRO, filed on Feb. 17, 2012; to U.S. Provisional Patent Application No. 61/600,153, entitled “CATALYST COMPOSITION WITH INCREASED BULK ACTIVE SITE ACCESSIBILITY FOR THE CATALYTIC THERMOCONVERSION OF BIOMASS TO LIQUID FUELS AND CHEMICALS”, Attorney Docket No. ID 260US-PRO, filed on Feb. 17, 2012; and to U.S. Provisional Patent Application No. 61/600,160, entitled “CATALYST COMPOSITION COMPRISING MATRIXES AND ZEOLITES WITH HIERARCHICAL PORE STRUCTURES FOR OPTIMUM ACTIVE SITE ACCESSIBILITY FOR USE IN THE CATALYTIC THERMOCONVERSION OF BIOMASS TO LIQUID FUELS AND CHEMICALS”, Attorney Docket No. ID 261US-PRO, filed on Feb. 17, 2012; the entire content of each being hereby incorporated by reference in its entirety herein. All publications and patents mentioned herein are hereby incorporated by reference in their entirety as if each individual publication or patent was specifically and individually indicated to be incorporated by reference.

### FIELD OF THE INVENTION

The invention relates to catalyst compositions and components thereof for use in a catalytic process, and more particularly in catalytic pyrolysis processes or gasification of solid biomass material and to catalyst compositions comprising a catalyst, a catalyst matrix material and a binder.

### BACKGROUND OF THE INVENTION

Biomass, in particular biomass of plant origin, is recognized as an abundant potential source of fuels and specialty chemicals. See, for example, “Energy production from biomass,” by P. McKendry, Bioresource Technology 83 (2002) pp. 37-46 and “Coordinated development of leading biomass pretreatment technologies” by Wyman et al., Bioresource Technology 96 (2005) pp. 1959-1966. Refined biomass feedstock, such as vegetable oils, starches, and sugars, can be substantially converted to liquid fuels including biodiesel (e.g., methyl or ethyl esters of fatty acids) and ethanol. However, using refined biomass feedstock for fuels and specialty chemicals can divert food sources from animal and human consumption, raising financial and ethical issues.

Alternatively, inedible biomass can be used to produce liquid fuels and specialty chemicals. Examples of inedible biomass include agricultural waste (such as bagasse, straw, corn stover, corn husks, and the like) and specifically grown energy crops (like switch grass and saw grass). Other examples include trees, forestry waste such as wood chips and saw dust from logging operations, and waste from paper and/or paper mills. In addition, aquacultural sources of biomass such as algae, are also potential feedstocks for producing fuels and chemicals. Inedible biomass generally includes three main components: lignin, hemi-cellulose, and cellulose. Certain components (e.g., lignin) can reduce the chemical and physical accessibility of the biomass, which can reduce the susceptibility to chemical and/or enzymatic conversion.

Attempts to produce fuels and specialty chemicals from biomass can result in low value products (e.g., unsaturated, oxygen containing, and/or annular hydrocarbons). Although such low value products can be upgraded into higher value products (e.g., conventional gasoline, jet fuel), upgrading can require specialized and/or costly conversion processes and/or refineries, which are distinct from and incompatible with conventional petroleum-based conversion processes and refineries. Thus, the wide-spread use and implementation of biomass to produce fuels and specialty chemicals face many challenges because large-scale production facilities are not widely available and can be expensive to build. Furthermore, existing processes can require extreme conditions (e.g., high temperature and/or pressure, expensive process gasses such as hydrogen, which increases capital and operating costs), require expensive catalysts, suffer low conversion efficiency (e.g., incomplete conversion or inability to convert ligno-cellulosic material), and/or suffer poor product selectivity.

To date, a need remains for novel and improved processes, including catalyst compositions and components thereof, for the efficient conversion of solid biomass materials to produce fuels and specialty chemicals.

### SUMMARY OF THE INVENTION

Aspects of the invention relate to a catalyst component which can be a catalyst matrix and/or a binder material useful for biomass conversion. The catalyst matrix material and/or binder material includes hybrid silica-alumina having a controlled Lewis acidity, and having a controlled porosity providing optimized accessibility for reactants.

In some embodiments, the hybrid silica-alumina is one or more of silica doped alumina, alumina doped silica, silicoaluminate, and any mixture thereof. For example, the silica doped alumina can include alumina particles and silica, where the silica is distributed in pores in the alumina particles. The silica can also be doped on a surface of the alumina particles. The alumina doped silica may include alumina and silica, where the alumina is dispersed and doped on a surface of the silica. In some cases, the silicoaluminate includes alumina and silica, where the alumina is atomically dispersed in matrices in the silica.

In certain embodiments, the controlled Lewis acidity includes suppressed density of Lewis acid sites in the hybrid silica-alumina, and/or suppressed strength of Lewis acid sites in the hybrid silica-alumina. The controlled porosity, in some embodiments, is generated by using a pore regulating agent, which can be one or more of plastics, char, carbon black, a salt, and a carbohydrate template (e.g., cellulosic particles such as sawdust, starch, and sugar).

The hybrid silica-alumina, in some embodiments, can also act as a catalyst binder providing structural strength and attrition resistance to a catalyst composition.

In some examples, the catalyst matrix material or binder material can further include one or more of a refractory metal oxide, a transition metal oxide, an alumina material, a clay, and a silica material. For example, the alumina material can be one or more of alumina, soluble alumina, Boehmite, pseudoboehmite, and aluminum chlorohydrate. The clay may be kaolin clay. The silica material can be one or more of silica, soluble silica, colloidal silica, silicic acid, polysilicic acid propylsulfonic acid modified silica, silica sol, and silica gel.

Other aspects relate to a catalyst composition for biomass catalytic cracking. The catalyst composition includes a zeolite catalyst, a binder; and a catalyst matrix comprising the catalyst matrix and binder material disclosed herein. In some embodiments, the zeolite catalyst can be mordenite inverted framework type zeolite and/or phosphorous promoted. The binder can be one or both of a silica material or a binder material and catalyst matrix material disclosed herein.

A further aspect of the present invention relates to a composition for biomass conversion. The composition includes the catalyst composition disclosed herein, and a biomass feedstock having a carbon ¹⁴C isotope content of about 107 pMC. In some embodiments, the biomass feedstock can be a particulated biomass, or a biomass pyrolysis product and/or by-product. For example, the biomass pyrolysis product can be a bio-oil vapor or a bio-oil.

A method for preparing a catalyst composition is also provided. The method includes: (a) preparing a slurry by mixing a catalyst matrix material disclosed herein, a zeolite catalyst, a binder as disclosed herein, and a pore regulating agent; (b) shaping the slurry to shaped bodies; and (c) removing the pore regulating agent from the shaped bodies, thereby producing a catalyst composition having the catalyst matrix material, the zeolite catalyst, and the binder, wherein the catalyst composition has a matrix phase having a hierarchical mesoporous-macroporous structure.

In some embodiments, in step (a), the pore regulating agent is one or more of plastics, char, carbon black, a salt, and a carbohydrate template. The carbohydrate template can be one or more of sawdust, cellulosic particle, starch, and sugar. The shaping in step (b), in some cases, can include spray-drying the slurry. The removing in step (c) can include washing out the pore regulating agent that is soluble, and/or calcining the pore regulating agent that is organic.

In certain embodiments, the method can further include, prior to step (a), producing hybrid silica-alumina, and using the hybrid silica-alumina in step (a) as the catalyst matrix material and/or the binder. Such producing can include one or more of: doping silica in pores in alumina particles to form silica doped alumina; doping silica on a surface of alumina particles to form silica doped alumina; doping alumina on a surface of silica to form alumina doped silica; and atomically dispersing alumina in matrices in silica to form silicoaluminate. The producing can further include mixing one or more of the silica doped alumina, alumina doped silica and silicoaluminate to produce the hybrid silica-alumina.

In accordance with another embodiment, a method for preparing a biomass conversion catalyst includes:
a) mixing an aqueous silica precursor and an alumina-containing binder thereby forming a slurry A;
b) adding a phosphorous-promoted zeolite and a clay to the slurry A thereby forming a slurry B;
c) shaping the slurry B thereby forming shaped bodies; and
d) calcining the shaped bodies thereby forming the biomass conversion catalyst.

In accordance with another embodiment, a method for preparing a biomass conversion catalyst includes:
a) utilizing a slurry C comprising an aqueous silica precursor;
b) adding a phosphorous-promoted zeolite and a clay to the slurry C thereby forming a slurry D;
c) adding an acid-peptized alumina binder to the slurry D thereby forming a slurry E;
d) shaping the slurry E thereby forming shaped bodies; and
e) without washing before or after, calcining the shaped bodies thereby forming the biomass conversion catalyst.

In various embodiments, the catalyst compositions of the present invention can have an increased catalyst life and/or higher attrition resistance. A reduced coke yield, improved bio-oil yield and/or a reduced oxygenated product yield can also be observed when such catalysts are used in biomass pyrolysis.

### BRIEF DESCRIPTION OF THE DRAWINGS

FIG. 1 is a plot showing the Nitrogen BJH pore volume distributions for samples of Catalysts C1-C5.

FIG. 2 is a plot showing relative coke yield of bio-oils separately produced from the thermo-catalytic conversion of biomass in the presence of Catalysts C1-C6.

FIG. 3 is a plot showing relative oil yield of bio-oils separately produced from the thermo-catalytic conversion of biomass in the presence of Catalysts C1-C6.

FIG. 4 is a plot showing relative oxygen in oil of bio-oils separately produced from the thermo-catalytic conversion of biomass in the presence of Catalysts C1-C6.

### DETAILED DESCRIPTION OF THE INVENTION

Aspects of the invention relate to methods, apparatus, kits and compositions for converting solid biomass into fuels and/or specialty chemicals. Suitable biomasses or biomass materials can include any biological material derived from living or previously living organisms, such as ligno-cellulosic biomass. More particularly, non-limiting examples of biomasses suitable for use in the process described herein can include inedible materials that do not compete with the food supply as well as materials that can be easily grown, materials that are otherwise readily available, and/or waste materials or by-products from pyrolysis plants, refineries, paper mills, etc. Some examples include grasses (including, for example, switch grass and saw grass), algae, sawdust, wood chips, wood bark, wood pulp, waste paper, twigs, straw, corn stover, cotton linters, bagasse, and the like. In various embodiments, biomasses include materials of photosynthetic origin (e.g., plants), such as materials made predominately of cellulose, hemi-cellulose, or lignin.

Aspects of the invention relate to pyrolysis processes for converting solid biomass to a bio-oil or gas in the presence of catalysts. In general, pyrolysis of biomass material can be carried out thermally, in the absence of a catalyst or in presence of a catalyst. Pyrolysis processes produce gaseous products (e.g., CO₂, CO, CH₄, H₂ and C₂H₄), liquid products (pyrolysis oil or bio-oil) and solid product (coke, char and ash). Pyrolysis processes can be modified as to produce less char and coke and more valuable products such as liquid products or valuable gas products. Examples of valuable liquid products include fuel such as jet fuels, diesel, and heating oil. Examples of valuable gas products include ethane, propane, and butane. The crude bio-oil may also be converted to suitable liquid transportation fuels in modified refinery processes such as fluid catalytic cracking, hydroconversion, thermal conversion, and the like. In these processes the bio-oil may be the sole feedstock, or it may be blended with conventional, crude oil-based feedstocks.

In general, increasing the liquid yield of biomass pyrolysis processes is desired. This can be achieved by using a fast heating rate, a short reaction time and a rapid quench of the liquid reaction products. Fluidized bed reactors with fast heating rates have been proposed for biomass pyrolysis processes. In some cases, heat is provided by injecting hot particulate heat transfer medium particles (e.g., char or sand) into the reactor.

To improve the conversion efficiency of the biomass into fuels, solid biomass can be prepared using various methods before pyrolysis. In some embodiments, biomass can be pre-treated prior to interacting the biomass with the catalyst. In some embodiments, the biomass is subjected to a pre-treatment such as torrefaction, swelling, impregnation, precipitation, adsorption, co-milling, steam explosion, etc. Pre-treatment can also include biomass size reduction to generate particulate biomass.

Catalysts

Aspects of the invention relate to treating the biomass with a catalyst. In some embodiments, the use of suitable catalysts leads to increase of the yield of organic compounds usable as a fuels, feedstocks and specialty chemicals, while resulting in reduction of the yield of undesirable products such as coke, tar and unconverted biomass.

As used herein, the term “catalyst” or “catalyst composition” refers to any material that facilitates the conversion of organic components of the biomass into bio-oils, fuels, specialty chemicals or precursors thereof. In some embodiments, aluminosilicate minerals, commonly known as zeolites, or modified zeolites, can be used.

Zeolites are crystalline aluminosilicates built from TO₄ units (T being Si and/or Al) that are arranged in such a manner that intra crystalline pores, channels and cavities are created with molecular dimensions. In some embodiments, the zeolite can be a mordenite inverted framework type zeolite (MFI). In some embodiments, the zeolite can be a ZSM-5, H-ZSM, Na-ZSM, beta-zeolite or mixture thereof. Generally, the pores of non-modified MFI-type zeolites have diameters less than 20 Angstroms (Å), for example, in the range of 4 to 12 Angstroms and are classified as being micropores based on the IUPAC classification of porous materials. The sizes and shapes of the micropores are determined by the specific crystallographic structure of the zeolite, providing the molecular sieve effects which can be unique to different crystal architectures of the individual zeolites. These unique architectural microporous zeolite crystal structures allow for shape-selective molecular absorption and catalysis, based on molecular exclusion (or hindered diffusion) and inclusion, of the reactants and products. The inclusion/exclusion processes which determine the reactant molecules that can enter the zeolite pore structure to react, as well as the reactive pathway, are governed by the sterically confined reaction space surrounding the catalytically active acid sites, most of which are located within the micropores.

In some embodiments, modified zeolites that have increased porosity can be used as biomass pyrolysis catalyst to accommodate large reactants (e.g., biomolecules). For example, modified zeolites with mesoporous (e.g., pore diameter of about 20 Angstroms to about 500 Angstroms) and/or macroporous (e.g., pore diameter of larger than about 500 Angstroms) structures can be used.

The catalyst can be regenerated after each use. In a typical catalytic pyrolysis process, feed is injected onto hot, fluidized catalyst where large biomolecules are broken into smaller molecules, olefins and coke. The vapor-phase products are separated from the catalyst and distilled into various products. The catalyst can then be circulated to a regenerator where air can be used to burn coke off its surface to regenerate the catalyst.

The catalyst can be provided in the form of particles or microspheres. The fluidized thermolysis of solid particulate biomass using zeolite-containing catalytic particles or microspheres not only provides fast and efficient heat transfer to the solid biomass but also improves yield and selectivity. It is also desirable for the catalyst to be attrition resistant, while maximizing bio-oil yield and minimizing coke formation.

The catalyst activity and selectivity can be strongly influenced by the type of matrix and/or binder that is used in the catalyst composition. A matrix and/or binder can provide strength, attrition resistance, and/or complementary catalytic activity. Moreover, the matrix/binder porosity can also affect the diffusion of reactants and products to and from the zeolite active sites. The current invention, in some embodiments, uses hybrid silica-alumina with suppressed Lewis acid density and/or strength. The hybrid silica-alumina can be used as catalyst matrix and/or binder, can improve biomass conversion activity and selectivity, and can produce bio-oils of improved quality.

Hybrid Silica-Alumina as Catalyst Matrix and/or Binder

Certain aspects of the present invention relates to catalyst compositions or formulations comprising active zeolites, which includes hybrid silica-alumina used as a matrix and/or binder that provides structural support for zeolites and/or complementary catalytic functions to the zeolite components. Such matrix and/or binder also provides little restriction for reactants to access zeolite components, as well as structural strength and attrition resistance. The hybrid silica-alumina can be one or more of silica doped alumina, alumina doped silica, silicoaluminate, and any mixture thereof.

In one embodiment, silica doped alumina can be used. Silica can be either homogeneously distributed in all or part of alumina pores, or doped on the surface layer of alumina particles. Silica doping to the surface of alumina can result in the passivation or suppression of Lewis acid sites present on pure alumina surface. For catalytic reactions where strong Lewis acidity is undesirable, for example, due to excessive coking formation as in cellulosic biomass thermal catalytic conversion, elimination of the strong Lewis acid sites can reduce undesirable side reactions. Such silica doped alumina can be formulated into a catalyst composition containing zeolites.

More specifically, silica doped alumina can be made by one or more of the following methods:

(a) A silica source can be added during the precipitation of soluble aluminum salts, followed by crystallization to form Boehmite, which may be then calcined to form the silica doped transition phase alumina, e.g., gamma-alumina, eta-alumina, theta-alumina, alpha-alumina, etc.

(b) A silica bearing source can be impregnated on an alumina substrate, e.g., amorphous alumina, pseudo-crystalline alumina or crystalline alumina, followed with calcination at high temperature.

(c) A silica bearing source can be mixed with aluminum chlorohydrate (ACH), or aluminum nitrohydrate (ACN), and allowed to react, followed with calcinations.

(d) Silica doping can be done on an alumina substrate that has been treated with a pore regulating agent (PRA) and has meso/macroporous structure. Alternatively, the doping can be done simultaneously with the application of the PRA on the alumina substrate followed with calcinations.

(e) The source of alumina can be a low cost one, such as but not limited to, Bauxite, Gibbsite, flush calcined Gibbsite, etc.

(f) The source of silica can be sodium silicate, silicic acid, polysilicic acid, colloidal silica, silica gel, silica containing compounds, tetraethylorthosilicate (TEOS), etc.

(g) Calcinations and/or steaming can be used to fix the silica on the alumina substrate, and to optimize the silica to alumina ratio, acidity, particle size distribution, etc. of the doped alumina.

(h) Solid state thermal reactions can be used to dope alumina with silica. For example, a Gibbsite alumina can be mixed with fine powder “Cabosil” silica, milled to obtain a homogeneous dispersion of the two powders and calcined, to produce a silica doped transition phase alumina. A PRA can be included during the milling as well.

(i) More than one dopant can be included, such as alkaline earth metals, transition metals and rare earth metals. For example, Ca, Mg, and/or La can be used to stabilize the silica to alumina ratio, and/or porosity of the aluminum substrate, such that no substantial changes occur with the thermal aging during catalytic service.

In another embodiment, alumina can be doped on silica surface to make alumina doped silica. For example, isolated alumina can be highly dispersed in and have strong interaction with silica such that the Lewis acidity that is typical of pure alumina can be reduced. Alumina doped silica can be made by one or more of the following methods:

(a) An alumina source can be added during the precipitation of soluble silica salts, followed by crystallization and calcination.

(b) An alumina bearing source can be impregnated on a silica substrate which can be amorphous silica, pseudo-crystalline silica or crystalline silica, followed with calcination at high temperature.

(c) An alumina bearing source can be mixed with silica sol or gel, and allowed to react, followed with calcinations.

(d) Alumina doping can be done on a silica substrate that has been treated with a PRA and has meso/macroporous structure. Alternatively, the doping can be done simultaneously with the application of the PRA on the silica substrate followed with calcinations.

(e) The source of alumina can be a low cost one, such as but not limited to, Bauxite, Gibbsite, flush calcined Gibbsite, etc.

(f) The source of silica can be sodium silicate, silicic acid, polysilicic acid, colloidal silica, silica gel, silica containing compounds, TEOS, etc.

(g) Calcinations and/or steaming can be used to fix the alumina on the silica substrate, and optimize the silica to alumina ratio, acidity, particle size distribution, etc. of the doped silica.

(h) More than one dopant can be included, such as alkaline earth metals, transition metals and rare earth metals. For example, Ca, Mg, and/or La can be used to stabilize the silica to alumina ratio, and/or porosity of the aluminum substrate, such that no substantial changes occur with the thermal aging during catalytic service.

In yet another embodiment, homogeneous silicoaluminate compositions can be formulated into catalyst composition containing zeolites. The alumina can be atomically dispersed in the matrices of silica.

The silica doped alumina, alumina doped silica, and silicoaluminate as described above can be either used alone or in mixtures. They can also be mixed with other refractory metal oxides as matrix and/or binder.

In various embodiments, the silica doped alumina, alumina doped silica, and/or silicoaluminate matrices can be synthesized with controlled porosity and/or acidity, so as to augment the catalytic functions of formulated catalysts. The silica doped alumina, alumina doped silica, and/or silicoaluminate can also be used as catalyst binder and can bring improved attrition resisting strength to formulated catalyst particles.

For example, hybrid silica-alumina materials can be prepared in high porosity, to bring the advantage of, for example, high accessibility for macromolecular reactants to the catalyst formulation. The silica to alumina ratio in the preparation can also be varied to obtain desired composition and structural phases. Changing the silica to alumina ratio also allows for controlling the surface acidity strength, acid type, and other properties so that such properties are compatible with the catalyzed reactions. Such hybrid silica-alumina materials as matrix and/or binder can be prepared with little Lewis acidity and high accessibility to macromolecular reactants. Of particular relevance, this invention provides improved catalyst matrix and/or binder material, which can lead to reduced coke formation, improved attrition resistance, improved bio-oil yield, and improved catalyst life in formulated zeolite catalysts for cellulosic biomass conversions, as compared to other matrix/binder such as refractory metal oxides.

Porosity

In some embodiments, the pore structure of the hybrid silica-alumina and/or matrix material can have pore sizes (e.g., diameters) ranging from about 20 to about 5,000 Angstroms, from about 100 to about 5,000 Angstroms, from about 200 to about 2,000 Angstroms, from about 100 to about 2,000 Angstroms, from about 500 to about 5,000 Angstroms, or from about 300 to about 10,000 Angstroms, or larger or smaller. For example, the hybrid silica-alumina and/or matrix material can have mesoporosity (e.g., pore diameter of about 20 Angstroms to about 500 Angstroms) or macroporosity (e.g., pore diameter of larger than about 500 Angstroms), or a mixed meso/macroporosity.

A pore regulating agent (PRA) can be used to regulate porosity of the hybrid silica-alumina and/or catalyst composition. PRAs can be added to the catalyst slurry before spray-drying to create the desired meso/macroporosity. Suitable PRAs include, but not limited to, plastics, char, carbon black, a salt, and carbohydrate templates. Said PRAs can be soluble (e.g., in an inorganic, such as water, or organic solvent, or a mixture thereof) and washed out from the spray-dried catalyst particles or microspheres, or be combustible (e.g., organic materials) and burned off, so as to create the desirable pore volume and structure that will increase the accessibility of the catalytic active sites in the bulk of the catalyst microspheres or particles.

In some embodiments, the PRA is an organic material which can be combustible when calcined in air, so that when the organic material escapes from the catalyst microsphere in a gaseous form, it leaves behind extra bulk porosity and pathways. For example, low cost materials derived from agricultural products can be used as pore regulating agents. These materials have the advantage of not being hazardous to human health, being producible at relative low cost compared to known pore regulating agents such as carbon black and soluble organic polymers. These materials include, but are not limited to, cellulosic types, starch, sawdust, corn flowers, wood flowers, shortgum, gums, and the like.

In some embodiments, combustible organic materials can also include waste plastics, for example, those selected and collected from the municipal solid waste. Such materials can be crushed to small size chips, ground and pulverized in high energy mills to produce fine powders having particles sizes in the micron and submicron ranges. In other embodiments, fine powders can be produced using vortex cyclonic jet mills, as described in U.S. Pat. No. 6,971,594, incorporated herein by reference in its entirety.

According to some embodiments, materials with ligno-cellulosic compositions such as woody materials from forestry or agricultural cellulose products such as corn stover, sugar bagasse, and the like, can be processed similarly to fine powders with defined particle sizes in the micron and submicron ranges. In some embodiments, the organic materials may include saw dust produced in wood mills.

In use, a catalyst precursor can be prepared from spray drying a slurry that contains a zeolite (e.g., ZSM-5), a clay (e.g., calcined kaolin), a binder (e.g., sodium silicate), and a hybrid silica-alumina source. Possible hybrid silica-alumina include silica doped alumina, alumina doped silica, and/or silicoaluminate. A PRA can be added before the spray drying step as a method of decreasing diffusion limitations. A variety of materials can be used for the PRA including carbon black, polymers, a salt, plastics, and such agricultural products as glucose, starch, sawdust, etc. Increased porosity and a hierarchical pore structure can be obtained by calcining or washing the spray dried microspheres to burn off or extract the PRA component, respectively.

Acidity

Increasing the number of Lewis type acid sites in the zeolite crystal lattice can promote primarily free radical hydrocarbon reactions that can enhance the formation of heavy molecules and coke. Thus, the Lewis acidity may be undesirable as it promotes free-radical type reactions that lead to polymerization of the product molecules resulting in heavy and tarry products and coke formation. Reducing the number of acid sites, on the other hand, can result in a decrease of the over-cracking of the large molecules and in a decrease in coke formation and catalyst deactivation. In particular, reduction of the number of acid sites located at the external surface of the zeolite crystals that preferentially interact with the larger molecules of the crude bio-oil feed which cannot enter the small zeolite pores openings, can favor cracking of larger molecules and result in a more efficient and selective biomass thermoconversion.

One objective of the current invention is to eliminate the disadvantage of high Lewis acidity by preparing biomass conversion catalysts with a significantly suppressed Lewis acid density and/or strength. The formation of hybrid silica-alumina such as silica doped alumina, alumina doped silica, and silicoaluminate, can suppress Lewis acidity as discussed above.

For example, approaches that can be used to reduce the undesirable Lewis acidity include doping silica on the alumina surface, doping highly dispersed alumina on silica surface, and/or atomically dispersing alumina in the silica matrices. Varying the silica to alumina ratio can also allow the number and strength of Lewis acid sites to be modified so as to control the catalytic activity.

Accordingly, various approaches to obtain a matrix/binder composition with minimum number of Lewis acid sites can be used. As discussed above, exemplary methods to obtain the desired silica doped alumina matrix composition include: adding silica during precipitation of soluble aluminum salts; impregnating silica on amorphous alumina; doping silica on an alumina treated with PRA; and/or promoting solid state reactions between powdered alumina (e.g., Gibbsite) and powdered silica (e.g., Cabosil). Exemplary methods to produce alumina doped silica include: adding an alumina source during precipitation of soluble silica salts; impregnating alumina on amorphous silica; reacting alumina source with silica sol; and/or impregnating alumina on macroporous silica obtained by use of PRA. Source of silica can be sodium silicate, silicic acid, polysilicic acid, colloidal silica, silica gel, TEOS (tetraethylorthosilicate), etc. Source for alumina can be Boehmite, Bauxite, Gibbsite, etc. In addition, alumina and/or silica can be doped with other metals such as alkaline earth metals, transition metals, and rare earth metals, e.g., Ca, Mg, or La.

The active-site acidity and the total number of active acidic sites can also be adjusted via modification of the zeolite framework, and by avoiding high density of strong acid sites that can cause over cracking and excess coke formation.

In some embodiments, optimization of the number of Lewis acid sites can be tuned by optimizing hybrid silica-alumina to zeolite weight ratio. For example, the mixed hybrid silica-alumina to zeolite weight ratio can be less than 1:5, less than 1:10 or less than 1:20.

Catalyst Matrix Materials

One or more types of hybrid silica-alumina discussed above, or one or more different phases of the same hybrid silica-alumina, can be included in the total matrix of the catalyst particles. The matrix can contain additional materials, such as, but not limited to, a refractory metal oxide, a transition metal oxide, an alumina material, a clay, and/or a silica material. For example, the alumina material can be one or more of alumina, soluble alumina, Boehmite, pseudoboehmite, and aluminum chlorohydrate. The clay, in one embodiment, can be kaolin clay. The silica material may be one or more of silica, soluble silica, colloidal silica, silicic acid, polysilicic acid, propylsulfonic acid modified silica, silica sol, and silica gel.

A preferred matrix composition for catalytic biomass thermoconversion can include one or more of the silica doped alumina, alumina doped silica, and silicoaluminate described above, together with a silica matrix/binder and Kaolin clay. They can be used alone or mixed with other refractory metal oxides as matrix/binder. In some embodiments, the hybrid silica-alumina can be prepared in desired porosity and/or acidity. The hybrid silica-alumina synthesized with controlled porosity and/or acidity can augment the catalytic functions of formulated catalysts, while bringing improved attrition resisting strength to formulated catalyst particles.

Catalyst Binder Materials

The metal phosphates discussed above, or any mixture thereof, can be used as a catalyst binder material. One or more types of metal phosphates, or one or more different phases of the same metal phosphate, can be included in the binder of the catalyst particles. The binder can contain additional materials, such as, but not limited to, a refractory metal oxide, a transition metal oxide, an alumina material, and a silica material. For example, the alumina material can be one or more of alumina, soluble alumina, Boehmite, pseudoboehmite, and aluminium chlorohydrate or transition type alumina. The silica material may be one or more of silica, soluble silica, colloidal silica, silicic acid, polysilicic acid, propylsulfonic acid modified silica, silica sol, and silica gel.

A binder composition for catalytic biomass thermal conversion can comprise one or more aluminum phosphate phases described above with a silica matrix/binder, as well as Kaolin clay.

Catalyst Compositions and Preparation

Another aspect of the invention relates to an improved catalyst composition for biomass catalytic cracking. The catalyst composition includes a catalyst matrix comprising the catalyst matrix material disclosed herein. In some embodiments, hybrid silica-alumina can be used as the catalyst matrix material and/or binder, and be present at about 1% by weight, about 5% by weight, about 10% by weight, about 20% by weight, or more or less, of the catalyst composition.

Aspects of the invention relate to catalyst compositions comprising zeolites and hybrid silica-alumina having optimized porosity, acidity and/or number of the Lewis acid sites for use in the thermoconversion of biomass. In some embodiments, the catalyst composition for biomass thermoconversion comprises a mordenite framework inverted-type zeolite (MFI), a hybrid silica-alumina, a clay, and a binder.

Some aspects of the invention also relate to methods to prepare the catalyst compositions disclosed herein. One method for preparing a catalyst composition can include: (a) preparing a slurry by mixing the catalyst matrix material disclosed herein, a zeolite catalyst, a binder, and a pore regulating agent; (b) shaping the slurry to shaped bodies; and (c) removing the pore regulating agent from the shaped bodies, thereby producing a catalyst composition having the catalyst matrix material, the zeolite catalyst, and the binder, wherein the catalyst composition has a matrix phase having a hierarchical mesoporous-macroporous structure.

For example, a catalyst precursor can be prepared from spray drying slurry that contains a zeolite (e.g., ZSM-5), a clay (e.g., kaolin), a matrix/binder containing silica-alumina with significantly suppressed Lewis acid density, and a pore regulating agent.

The MFI-type zeolite, in some embodiments, can be a ZSM-type zeolite such as ZSM-5 or ZSM-12. The MFI-type zeolite can also be mixed with a Faujasite-type zeolite, such as Zeolite Y, USY zeolite, REUSY zeolite, DAY zeolite, dealuminated USY zeolite and combination thereof. The zeolite can be commercial zeolites subjected to chemical treatments with acids and bases of the zeolite crystals, ion-exchange (e.g., NH₄⁺) treatments, hydrothermal treatments (e.g., steaming and calcining), and/or incorporation of a pore regulator agent (PRA). The zeolite present in the catalyst composition can also be a phosphorous promoted zeolite, and can be promoted with phosphorous prior to incorporation into the catalyst or during catalyst formation or promoted on the zeolite after catalyst formation. The treated, pre-crystallized zeolite particles can then incorporated into a slurry, together with binder and other matrix components, such as clay and hybrid silica-alumina, where the slurry can be spray dried to form the microspheres containing the embedded zeolite crystals. The zeolite can also be made from direct synthesis of zeolites using implanted combustible templates, e.g., via in-situ growth on pre-formed clay-based microspheres.

In some embodiments, the zeolite, such as an MFI or ZSM type, can be mixed with a hybrid silica-alumina to form a mixture. In some embodiments, the zeolite and the hybrid silica-alumina are mixed in a slurry form. In other embodiments, the zeolite and the hybrid silica-alumina can be mixed thoroughly in their powder form, and the mixture can be subsequently subjected to steaming or calcination. The ratio by weight of the hybrid silica-alumina to the zeolite, on a dry basis, can be less than 20%, less than 10%, or less than 5%, or more or less. The mixture can then be slurried with the clay and binder in water and spray dry to form microspheres.

In some embodiments, hybrid silica-alumina can be mixed with zeolites and clays (serving as matrix, diluents, extenders, substrates, etc.), to form a slurry and spray dried. The clay can be kaolin clay. The clay's content can vary from about 5% to about 40%, or from about 10% to about 20%, or more or less.

In some embodiments, other binders such as silica sol, polysilicic acid, alumina, silica-alumina, phosphate, or any combination of the foregoing can be included. The ranges of the binder's content can depend on the particular type of binder and on the zeolite content used. For example, the ranges of the binder's content can vary from about 5% to about 40%, or from about 10% to about 20%, or more or less.

In some embodiments, a pore regulating agent can be mixed with the hybrid silica-alumina to create the desired porosity (e.g., meso/macroporosity). In some embodiments, the pore regulating agent can be an organic material selected from the group consisting of compounds containing cellulosic type, starch, sawdust, corn flour, wood flour, shortgum, gums, corn stover, sugar cane bagasse, plastic, resin, rubber, carbohydrates, organic polymers, a salt, or mixtures thereof. In some embodiments, the pore regulating agent can be carbon black.

The pore regulating agent, if soluble, can then be washed out, and/or calcined if the pore regulating agent is organic. Washing can be performed using an organic or inorganic solvent, or a combination thereof. Calcining can be carried out at a temperature from about 200° C. to about 1,200° C. for a time from about 0.1 hour to about 100 hours. In some embodiments, the calcination step is carried out at a temperature from about 550° C. to about 650° C. In some embodiments, the calcination step is carried out at about 600° C.

A slurry with one or more of the components of the catalyst composition, such as zeolite, hybrid silica-alumina, clay, pore regulating agent and/or other binder can be made and spray dried to form microspheres. After forming, the microspheres can optionally be steamed/or calcined. Subsequently, in some embodiments, the microspheres can optionally be washed and/or ion-exchanged. In some embodiments, the spray-dried microspheres can have an average particle diameter that is suitable for commercial fluid cracking catalysts. In some examples, the microspheres have an average size of about 50 μm, about 60 μm, about 70 μm, about 80 μm, about 90 μm or about 100 μm, or larger or smaller.

In accordance with another embodiment, a process for making a biomass conversion catalyst comprises:
a) mixing an aqueous silica precursor and an alumina-containing component thereby forming a slurry A;
b) adding a phosphorous-promoted zeolite and a clay to the slurry A thereby forming a slurry B;
c) shaping the slurry B thereby forming shaped bodies; and
d) calcining the shaped bodies thereby forming the biomass conversion catalyst (which can be without washing before or after calcining).

A pore regulating agent can also be added to the slurry B.

The aqueous silica precursor of the slurry A can comprise polysilicic acid, and the alumina-containing binder can be peptized by the polysilicic acid thereby forming a hybrid binder system, as described above, and the slurry A can be aged for a period of about 10 minutes to about 2 hours. The alumina-containing component can comprise an acid peptized alumina compound, which can be prepared by mixing an acid with an alumina-containing compound. The acid can be selected from the group consisting of nitric acid, sulfuric acid, phosphoric acid, and combinations thereof. The alumina-containing compound can be selected from the group consisting of kaolin, boehmite, pseudoboehmite, or any combination thereof.

The pHs of the slurry A and the slurry B can each be in the range of from about 1.5 to about 3.5. When a pore regulating agent is not used in the preparation of the catalyst, the biomass conversion catalyst has less than about 0.02 cm³/g pore volume of the mesopores in the range of 20-100 Å. When a pore regulating agent is used in the preparation of the catalyst, the biomass conversion catalyst has greater than about 0.04 cm³/g pore volume of the mesopores in the range of 20-100 Å.

In accordance with another embodiment, a process for making a biomass conversion catalyst comprises:
a) utilizing a slurry C comprising an aqueous silica precursor;
b) adding a phosphorous-promoted zeolite and a clay to the slurry C thereby forming a slurry D;
c) adding an acid-peptized alumina component to the slurry D thereby forming a slurry E;
d) shaping the slurry E thereby forming shaped bodies; and
e) without washing before or after, calcining the shaped bodies thereby forming the biomass conversion catalyst.

The acid-peptized alumina component can be prepared by mixing an acid with an alumina-containing compound, as described above. The alumina-containing compound can be selected from the group consisting of kaolin, boehmite, pseudoboehmite, and combinations thereof. A pore regulating agent can also be added to the slurry E.

The acid-peptized alumina component can be selected from the group consisting of aluminum chlorohydrate, polyaluminum chloride, and combinations thereof. The pHs of the slurry C, the slurry D, and the slurry E can each be in the range of from about 1.5 to about 3.5.

When a pore regulating agent is not used in the preparation of the catalyst, the biomass conversion catalyst has less than about 0.02 cm³/g pore volume of the mesopores in the range of 20-100 Å. When a pore regulating agent is used in the preparation of the catalyst, the biomass conversion catalyst has greater than about 0.04 cm³/g pore volume of the mesopores in the range of 20-100 Å.

Assessment of Non-Fossil Carbon in Biomass

Further aspects of the invention relate to methods and compositions for biomass conversion. The composition can include: the catalyst composition disclosed herein; and a biomass feedstock having a carbon ¹⁴C isotope content of about 107 pMC. In some embodiments, the biomass feedstock is a particulated biomass or a biomass pyrolysis product (e.g., a bio-oil vapor or a bio-oil) and/or by-product.

Renewable feedstocks such as biomass are characterized in that the biomass, for the growth thereof, has consumed atmospheric CO₂ while producing oxygen. Unlike the materials resulting from fossil materials, renewable feedstocks comprise ¹⁴C in the same proportions as atmospheric CO₂. One skilled in the art will appreciate that biomass or products derived from pyrolysis of the biomass, such as oil/vapor products, can be distinguished from products containing fossil carbon by the carbon ¹⁴C isotope content (also referred herein as radiocarbon).

Carbon ¹⁴C isotope is unstable, having a half life of 5730 years and the relative abundance of carbon ¹⁴C isotope relative to the stable carbon ¹³C isotope can enable distinction between fossil and biomass feedstocks. In some embodiments, the presence of ¹⁴C isotope can be considered as an indication that the feedstocks or products from pyrolysis include renewable carbon rather than fossil fuel-based or petroleum-based carbon. Carbon ¹⁴C isotope of the total carbon content of renewable feedstock or products derived from renewable feedstock is typically 100% whereas the carbon ¹⁴C isotope of the total carbon content of petroleum-based compounds is typically 0%.

Assessment of the renewably based carbon content of a material can be performed through standard test methods, e.g., using radiocarbon and isotope ratio mass spectrometry analysis. ASTM International (formally known as the American Society for Testing and Materials) has established a standard method for assessing the bio-based or renewable carbon content of materials. The application of the ASTM-D6866 can be used to derive bio-based or renewable carbon content, which is incorporated by reference in its entirety. The analysis can be performed by deriving a ratio of the amount of carbon ¹⁴C in an unknown sample compared to that of a modern reference standard. This ratio is reported as percent modern carbon or pMC. The distribution of carbon ¹⁴C isotope within the atmosphere has been approximated since its appearance, showing values that are greater than 100 pMC for plants and animals living since AD 1950. The distribution of carbon ¹⁴C isotope has gradually decreased over time with values of about 107.5 pMC. In some embodiments, biomass or compounds derived from biomass have a carbon ¹⁴C signature of about 107.5 pMC.

The present invention provides among other things catalyst compositions, processes of making the catalyst compositions and methods for converting biomass into fuel and chemicals. While specific embodiments of the subject invention have been discussed, the description herein is illustrative and not restrictive. Many variations of the invention will be come apparent to those skilled in the art upon review of this specification. The full scope of the invention should be determined by reference to the claims, along with their full scope of equivalents, and the specification, along with such variations.

### EXAMPLES

### Polysilicic Acid Slurry (PSA Slurry) Preparation

A quantity of a 20 wt % sodium silicate solution was prepared by diluting a quantity of sodium silicate (29 wt %) with sufficient deionized water.

The sodium silicate solution was contacted with ion exchange resin beads to exchange the sodium ions of the sodium silicate with H⁺ ions on the beads. The resulting PSA solution was substantially sodium free. The resulting pH of the PSA binder solution was about 1.3-2.

Alumina Slurry Preparation

Dry Catapal® alumina powder was combined with deionized water in a mix tank to form a salt-free alumina slurry.

Preparation of Catalyst C1

While mixing, a portion of the PSA slurry was added to the alumina slurry in a first mix tank until the pH reached about 2.1 and the mixture was then aged for about 30 minutes while maintaining the pH at between 2.1 and <2.4 by either adding additional PSA slurry or HNO3.

A portion of the PSA slurry and an aqueous zeolite slurry containing bead-milled P-ZSM-5 (having a pH of about 2), were added to a second mix tank. The contents of the first mix tank were added to the second mix tank, and the pH was maintained between 2.1 and 2.4 through the addition of HNO3, as needed.

Dry kaolin clay was then added to the second mix tank contents, with mixing. The contents of the second mix tank were then spray dried thereby forming a catalyst. The spray dried catalyst was then calcined without any water washing before or after calcination.

Preparation of Catalyst C2

While mixing, HNO3 was added to the alumina slurry in a first mix tank until the pH reached about 2.1 and the mixture was then aged for about 30 minutes while maintaining the pH at between 2.1 and <2.4 by adding HNO3, as needed.

A quantity of the PSA slurry and an aqueous zeolite slurry containing bead-milled P-ZSM-5 (having a pH of about 2.2), were added to a second mix tank. The contents of the first mix tank were added to the second mix tank, and the pH was maintained between 2.1 and 2.5 through the addition of HNO3, as needed.

Dry kaolin clay was then added to the second mix tank contents, with mixing. The contents of the second mix tank were then spray dried thereby forming a catalyst. The spray dried catalyst was then calcined without any water washing before or after calcination.

Preparation of Catalyst C3

A quantity of the PSA slurry was added to a mix tank along with deionized water. A quantity of an aqueous zeolite slurry containing bead-milled P-ZSM-5 was added to the mix tank. Dry kaolin clay was then added to the mix tank contents, with mixing, followed by the addition of aluminum chlorohydrate. The contents of the mix tank were then spray dried thereby forming a catalyst. The spray dried catalyst was then washed with water followed by calcination.

Preparation of Catalyst C4

While mixing, a portion of the PSA slurry was added to the alumina slurry in a mix tank until the pH reached about 2.1 and the mixture was then aged for about 30 minutes while maintaining the pH at between 2.1 and <2.4 by either adding PSA slurry or HNO3.

A quantity of an aqueous zeolite slurry containing bead-milled P-ZSM-5 was added to the mix tank. A quantity of aluminum chlorohydrate was then added to the mix tank and the pH was kept below 2.5 by the addition of either the PSA slurry or HNO3. Any remaining PSA slurry was then added to the mix tank.

Dry kaolin clay was then added to the mix tank contents, with mixing, followed by the addition of sucrose. The contents of the mix tank were then spray dried thereby forming a catalyst. The spray dried catalyst was then washed with water followed by calcination.

Preparation of Catalyst C5

A quantity of dry kaolin was slurried in deionized water in a mix tank. Phosphoric acid and monoammonium phosphate were added to the mix tank and mixed for 10 minutes. A quantity of an aqueous zeolite slurry containing bead-milled P-ZSM-5 was added to the mix tank followed by the addition of colloidal silica. The pH of the mix tank contents were then kept below 2.6 by the addition of HNO3, as needed. The contents of the mix tank were then spray dried thereby forming a catalyst. The spray dried catalyst was then calcined without any water washing before or after calcination.

Table 1 below shows physical property data for Catalysts C1-C5. As can be seen in the data, the catalyst attrition index (AI) ranged from 2.2-8.8, indicating excellent attrition resistance for these materials. Also, the attrition indexes and the apparent bulk densities for Catalysts C1-C5 indicate that there is a synergy between the SiO₂ and Al2O3 binding systems, given that Catalysts C1-C5 did not contain enough of either material to adequately bind a catalyst by itself.

TABLE 1

| Property | Method | C1 | C2 | C3 | C4 | C5 |
|---|---|---|---|---|---|---|
| Attrition | ASTM | 2.2 | 8.8 | 4.2 | 2.2 | 4.6 |
| Index | D5757 | | | | | |
| Apparent | ASTM | 0.77 | 0.71 | 0.74 | 0.8 | 0.76 |
| Bulk Density | B329 | | | | | |
| Total Surface | BET plot, | 138 | 138 | 133 | 194 | 131 |
| Area (TSA) | p/po = | | | | | |
| | 0.01-0.10 | | | | | |
| Meso Surface | t-plot, | 30 | 24 | 46 | 117 | 51 |
| Area (MSA) | 3.5-5.0 Å | | | | | |
| Micro Surface | ZSA = | 108 | 114 | 87 | 77 | 80 |
| Area | TSA − | | | | | |
| | MSA | | | | | |
| Loss on | TGA | 10.3 | 9.8 | 2.6 | 2.4 | 7.0 |
| Ignition | method | | | | | |

Table 2 below lists the nominal compositions for Catalysts C1-C5.

TABLE 2

| | wt % | wt % | wt % | wt % | wt % P₂O₅ |
|---|---|---|---|---|---|
| Catalyst | Silica | Alumina | Kaolin | P-ZSM-5 | added |
| C1 | 18 | 5 | 37 | 40 | 0 |
| C2 | 18 | 5 | 37 | 40 | 0 |
| C3 | 18 | 4 | 43 | 35 | 0 |
| C4 | 16 | 9 | 40 | 36 | 0 |
| C5 | 20 | 0 | 44 | 30 | 6 |

Nitrogen Adsorption-Desorption Isotherm Testing of Catalysts C1-C5

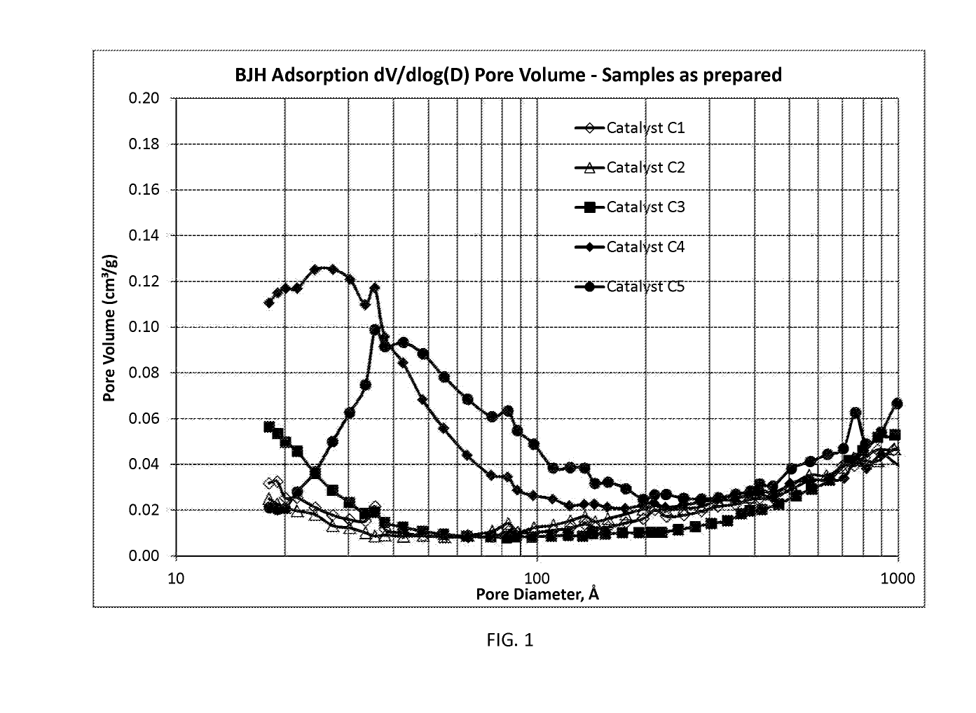

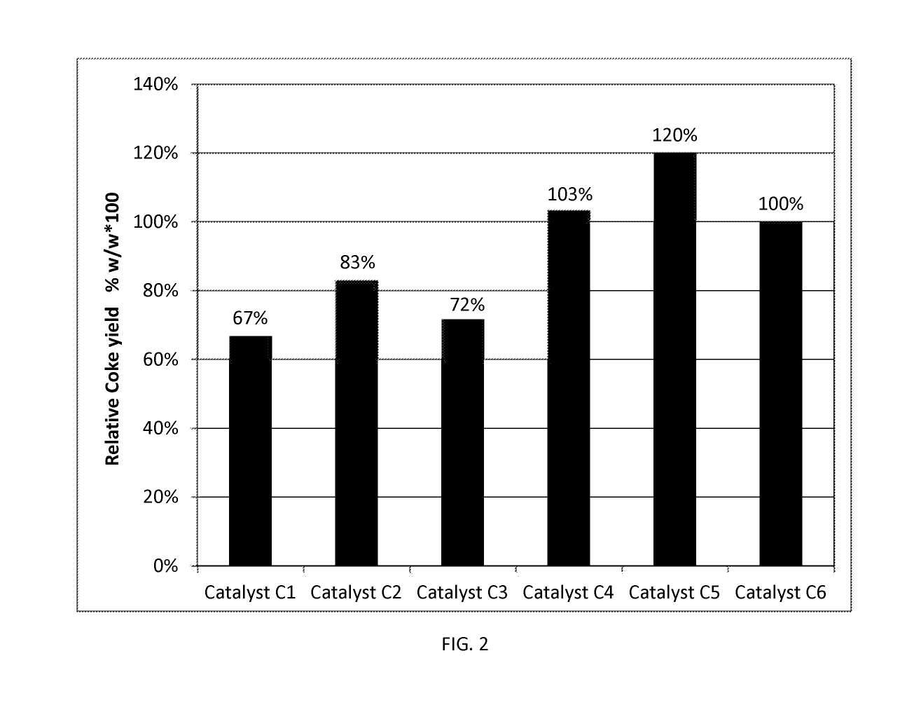

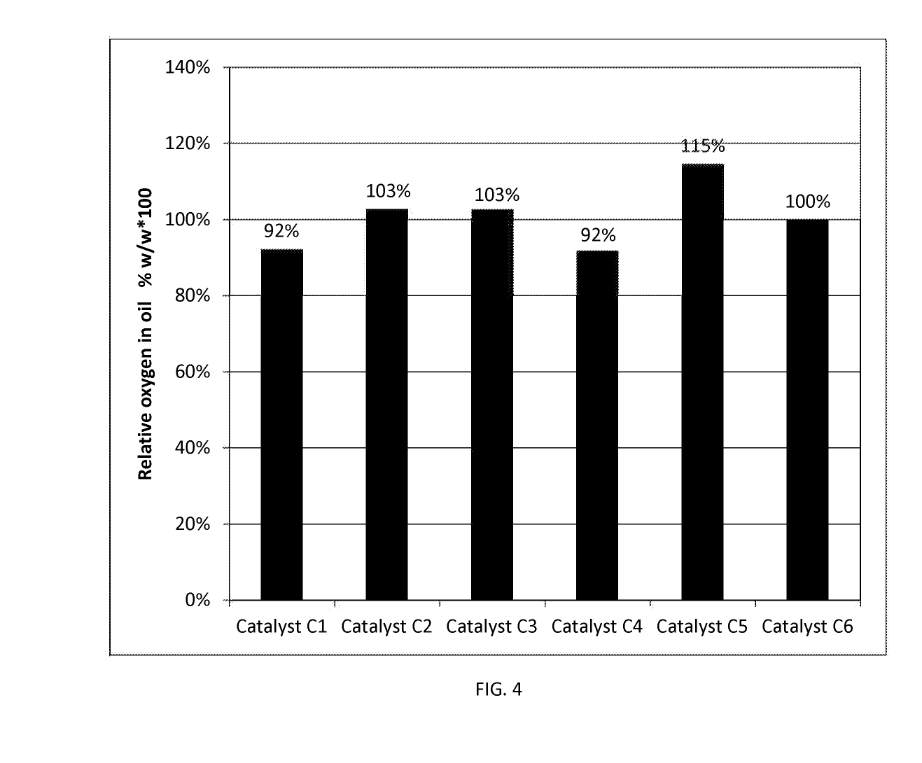

Fresh Catalysts C1-C5 were subjected to Nitrogen adsorption-desorption isotherm testing per ASTM D4222 at about 77° K and pore size distributions were obtained from the adsorption branch of the nitrogen isotherms and discretized according to the BJH pore size distribution model. FIG. 1 shows the Adsorption BJH pore volume distributions for catalysts C1-C5 as pore volume vs. pore diameter. With proper application of the silica-alumina hybrid binder the pore size distribution of the catalyst can be controlled. Catalysts C1 and C2 exhibited the lowest pore volume in the range 20-100 Å of approximately 0.01 cm³/g. Catalyst C3 represents an intermediate case, with a pore volume in the range 20-100 Å of about 0.014 cm³/g. These examples, as can be seen in FIG. 2, yield less coke than the commercially available alumina binder catalyst C6. Catalyst C4, which was made with sucrose pore regulating agent, shows significantly increased pore volume in the range 20-100 Å of approximately 0.06 cm³/g, which results in reduced oxygen in oil compared to Catalyst C6 (see FIG. 4). Finally, Catalyst C5 had pore volume in the range 20-100 Å of approximately 0.05 cm³/g. The combination of hybrid alumina and silica in Catalyst C5 allows for minimum pore volume in the range <˜30 Å and maximum at ˜40 Å. Note that these pore volume distributions and descriptions do not include zeolite.

Biomass Conversion Using Catalysts C1-C5 and Commercial Catalyst C6 in a Laboratory Scale Biomass Conversion Batch Testing Unit

Each of the Catalysts C1-C5 and a commercially available FCC olefins catalyst containing ZSM-5 (referred to as Catalyst C6) were separately used as catalysts in the thermo-catalytic conversion of southern yellow pine wood chips in a laboratory scale biomass conversion batch testing unit. Prior to testing all 6 catalysts C1-C6 were calcined at 600° C. for 1 hour then subjected to steam treatment in 100% steam for 4 hours at 788 C to simulate unit deactivation. The conversion unit temperatures for the runs were each about 940° F. All runs were in the substantial absence of free oxygen. After separation of the product gases and vapors from the catalyst, the condensable portion of the product stream was condensed and allowed to gravity separate into aqueous and bio-oil phases.

FIG. 2 shows relative coke yield for each of Catalysts C1-05, all relative to the coke yield for commercially available alumina binder Catalyst C6. C1-C3 have lower coke yields relative to C4-C6 owing to the reduced pore volume in the range 20-100 Å.

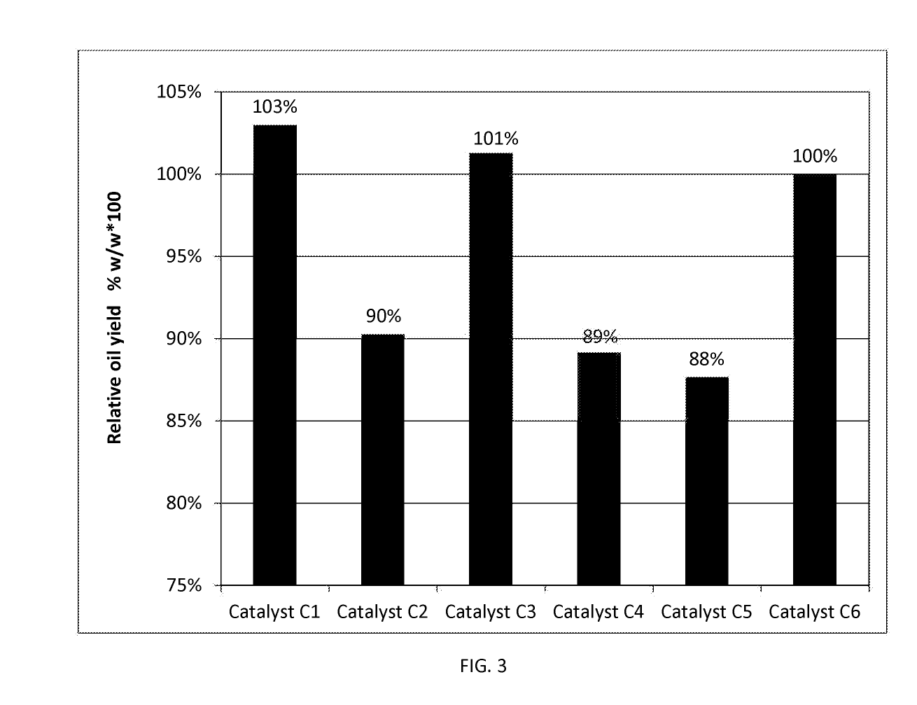

FIG. 3 shows relative oil yield for each of Catalysts C1-C5, all relative to the oil yield for commercially available alumina binder Catalyst C6. FIG. 3 shows that Catalysts C1 and C3 had similar relative oil yields as compared to commercial Catalyst C6, while the relative oil yields for Catalysts C2, C4 and C5 were not much lower.

FIG. 4 shows relative oxygen in oil for each of Catalysts C1-C5, all relative to the oxygen in oil commercially available alumina binder Catalyst C6. FIG. 4 shows that Catalysts C2 and C3 had similar relative oxygen in oil values as compared to commercial Catalyst C6, while the relative oxygen in oil for Catalysts C1 and C4 were significantly lower, and the relative oxygen in oil was significantly higher for Catalyst C5.

1. A catalyst component, comprising hybrid silica-alumina having a controlled Lewis acidity, and having a controlled porosity providing optimized accessibility for reactants.

2. The catalyst component of claim 1, wherein the catalyst component is a catalyst matrix material.

3. The catalyst component of claim 1, wherein the catalyst component is a catalyst binder providing structural strength and attrition resistance to a catalyst composition.

4. The catalyst component of claim 1, wherein the hybrid silica-alumina is one or more of silica doped alumina, alumina doped silica, silicoaluminate, and any mixture thereof.

5. The catalyst component of claim 4, wherein the silica doped alumina includes alumina particles and silica, wherein at least a portion of the silica is distributed in pores in the alumina particles.

6. The catalyst component of claim 4, wherein the silica doped alumina includes alumina particles and silica, wherein at least a portion of the silica is doped on a surface of the alumina particles.

7. The catalyst component of claim 4, wherein the alumina doped silica includes alumina and silica, wherein the alumina is dispersed and doped on a surface of the silica.

8. The catalyst component of claim 4, wherein the silicoaluminate includes alumina and silica, wherein the alumina is atomically dispersed in matrices in the silica.

9. The catalyst component of claim 1, wherein the controlled Lewis acidity includes suppressed density of Lewis acid sites in the hybrid silica-alumina.

10. The catalyst component of claim 1, wherein the controlled porosity is generated by using a pore regulating agent.

11. A catalyst composition for biomass catalytic cracking, comprising:
a zeolite;
a binder;
a clay; and
a catalyst matrix comprising the catalyst component of claim 1.

12. The catalyst composition of claim 11 wherein the binder is one or both of a silica material and the catalyst component of claim 1.

13. The catalyst composition of claim 11 wherein the clay is kaolin and the zeolite is ZSM-5.

14. The catalyst composition of claim 13 wherein the zeolite is phosphorous promoted.

15. A composition for biomass conversion, comprising:
the catalyst composition of claim 11; and
a biomass feedstock having a carbon ¹⁴C isotope content of about 107 pMC.

16. A process for preparing a catalyst composition comprising:
(a) producing a hybrid silica-alumina by a method selected from the group consisting of:
i) doping silica in pores in alumina particles to form silica doped alumina; ii) doping silica on a surface of alumina particles to form silica doped alumina; iii) doping alumina on a surface of silica to form alumina doped silica; iv) atomically dispersing alumina in matrices in silica to form silicoaluminate; and combinations thereof;
(b) preparing a slurry by mixing a catalyst matrix material comprising the hybrid silica-alumina, a zeolite, a binder, and a pore regulating agent;
(c) shaping the slurry to shaped bodies; and
(d) removing the pore regulating agent from the shaped bodies, thereby producing a catalyst composition having the catalyst matrix material, the zeolite catalyst, and the binder, wherein the catalyst composition has a matrix phase having a hierarchical mesoporous-macroporous structure.

17. A process for making a biomass conversion catalyst comprising:
a) mixing an aqueous silica precursor and an alumina-containing component thereby forming a slurry A;
b) adding a phosphorous-promoted zeolite and a clay to the slurry A thereby forming a slurry B;
c) shaping the slurry B thereby forming shaped bodies; and
d) calcining the shaped bodies thereby forming the biomass conversion catalyst.

18. The process of claim 17, wherein a pore regulating agent is also added to the slurry B.

19. The process of claim 17 wherein the aqueous silica precursor of the slurry A comprises polysilicic acid, and wherein the alumina-containing component is peptized by the polysilicic acid thereby forming a hybrid binder system.

20. The process of claim 19, wherein the slurry A is aged for a period of about 10 minutes to about 2 hours.

21. The process of claim 17 wherein the alumina-containing component comprises an acid peptized alumina compound.

22. The process of claim 21, wherein the acid-peptized alumina compound is prepared by mixing an acid with an alumina-containing compound.

23. The process of claim 22, wherein the alumina-containing compound is selected from the group consisting of kaolin, boehmite, pseudoboehmite, or any combination thereof.

24. The process of claim 22, wherein the acid is selected from the group consisting of nitric acid, sulfuric acid, phosphoric acid, and combinations thereof.

25. The process of claim 17 wherein the shaped bodies are calcined in step d) without washing before or after.

26. The process of claim 19, wherein the hybrid binder system is one or more of silica doped alumina, alumina doped silica, silicoaluminate, and any mixture thereof.

27. The process of claim 26, wherein the silica doped alumina comprises alumina particles and silica, wherein the silica is distributed in pores in the alumina particles.

28. The process of claim 26, wherein the silica doped alumina comprises alumina particles and silica, wherein the silica is doped on a surface of the alumina particles.

29. The process of claim 26, wherein the alumina doped silica comprises alumina and silica, wherein the alumina is dispersed and doped on a surface of the silica.

30. The process of claim 26, wherein the silicoaluminate comprises alumina and silica, wherein the alumina is atomically dispersed in matrices in the silica.

31. The process of claim 17, wherein the pHs of the slurry A and the slurry B are in the range of from about 1.5 to about 3.5.

32. The process of claim 17, wherein the biomass conversion catalyst has less than about 0.02 cm³/g pore volume of the mesopores in the range of 20-100 Å.

33. The process of claim 18, wherein the biomass conversion catalyst has greater than about 0.04 cm³/g pore volume of the mesopores in the range of 20-100 Å.

34. A process for making a biomass conversion catalyst comprising:
a) utilizing a slurry C comprising an aqueous silica precursor;
b) adding a phosphorous-promoted zeolite and a clay to the slurry C thereby forming a slurry D;
c) adding an acid-peptized alumina compound to the slurry D thereby forming a slurry E;
d) shaping the slurry E thereby forming shaped bodies; and
e) without washing before or after, calcining the shaped bodies thereby forming the biomass conversion catalyst.

35. The process of claim 34, wherein the acid-peptized alumina compound is prepared by mixing an acid with an alumina-containing compound.

36. The process of claim 35, wherein the acid is selected from the group consisting of nitric acid, sulfuric acid, phosphoric acid, and combinations thereof.

37. The process of claim 35, wherein the alumina-containing compound is selected from the group consisting of kaolin, boehmite, pseudoboehmite, and combinations thereof.

38. The process of claim 34, wherein a pore regulating agent is also added to the slurry E.

39. The process of claim 34, wherein the acid-peptized alumina compound is selected from the group consisting of aluminum chlorohydrate, polyaluminum chloride, and combinations thereof.

40. The process of claim 34, wherein the pHs of the slurry C, the slurry D, and the slurry E are in the range of from about 1.5 to about 3.5.

41. The process of claim 34, wherein the biomass conversion catalyst has less than about 0.02 cm³/g pore volume of the mesopores in the range of from 20-100 Å.

42. The process of claim 38, wherein the biomass conversion catalyst has greater than about 0.04 cm³/g pore volume of the mesopores in the range of from 20-100 Å.
